(19) United States
(12) Patent Application Publication
(10) Pub. No.: US 2012/0093908 A1
(43) Pub. Date: Apr. 19, 2012

(54) METAL OXIDE STERILIZING CATALYST, AND STERILIZING DEVICE AND SYSTEM INCLUDING THE SAME

(75) Inventors: Jae Eun Kim, Seoul (KR); Sang Min Ji, Suwon-si (KR); Joo Wook Lee, Seoul (KR); Hyo Rang Kang, Anyang-si (KR); Ho Jung Yang, Suwon-si (KR); Hyun Seok Kim, Seoul (KR); Chang Hyun Kim, Seoul (KR)

(73) Assignee: SAMSUNG ELECTRONICS CO., LTD., Suwon-si (KR)

(21) Appl. No.: 13/170,906

(22) Filed: Jun. 28, 2011

(30) Foreign Application Priority Data
Oct. 19, 2010 (KR) 10-2010-0102095

(51) Int. Cl. A01N 25/08; B01J 21/06; B01J 23/20; B01J 23/24; B01J 21/08; B01J 21/12; B01J 23/50; B01J 23/72; B01J 23/06; B01J 23/75; B01J 23/755; B01J 23/34; B01J 23/42; B01J 23/44; B01J 23/46; B01J 23/52; A01N 59/00; A01P 1/00; B01J 35/02

(52) U.S. Cl. 424/409; 502/300; 502/355; 502/349; 502/353; 502/305; 502/350; 502/240; 502/304; 502/263; 502/242; 502/347; 502/345; 502/343; 502/325; 502/337; 502/324; 502/339; 502/344; 424/613

(57) ABSTRACT

Disclosed is a sterilizing catalyst, a sterilizing device and a sterilizing system, the sterilizing catalyst includes a metal lattice including a metal oxide, and an oxygen vacancy-inducing metal that is integrated or encompassed within the metal lattice. The metal oxide is an oxide of a divalent or multivalent metal. The oxygen vacancy-inducing metal has an oxidation number lower than that of the divalent or multivalent metal.

### CROSS-REFERENCE TO RELATED APPLICATION

This application claims priority to and the benefit of Korean Patent Application No. 10-2010-0102095 filed in the Korean Intellectual Property Office on Oct. 19, 2010, the entire contents of which are incorporated herein by reference.

### BACKGROUND

1. Field

Example embodiments relate to a metal oxide sterilizing catalyst, a sterilizing device and a sterilizing system using the same.

2. Description of the Related Art

Recently, various antibacterial products have been manufactured in response to microorganic contamination observed in various environments and the demands for cleaner and safer environments. Antibacterial agents are generally characterized as either a chlorine type, an organic type, an inorganic type, etc. The number of products using inorganic type of antibacterial agents including silver has largely increased. Because silver (Ag) is known to be harmless to a human body and has excellent antibacterial effects for various microorganisms, it is used for sterilization of drinking water, kitchen utensils, various living goods, etc. Conventional antibacterial agents use the antibacterial activity of silver ions, wherein the silver ions released from the antibacterial agents directly play a role in the antibacterial activities. It is known that the released silver ions replace hydrogen atoms of a thiol group (—SH) in amino acids making up the enzyme of the microorganisms to form a sulfur-silver complex (—S—Ag). The sulfur-silver complex neutralizes the activity of the enzyme, or penetrates into a cell wall of the microorganisms to bond with DNA and disturb respiration.

### SUMMARY

Example embodiments relate to a metal oxide sterilizing catalyst, a sterilizing device and a sterilizing system using the same.

Example embodiments provide a sterilizing catalyst that may maintain continual sterilizing performance because silver ions are substantially retained.

Example embodiments provide a sterilizing catalyst exhibiting sterilizing activity at low temperature to room temperature.

Yet other example embodiments provide a sterilizing device using a sterilizing catalyst that may be used for sterilization at room temperature, and that exhibits continual sterilizing performance.

Still other example embodiments provide a sterilizing system including a sterilizing catalyst, and a reactive oxygen species generated by an oxygen vacancy of the sterilizing catalyst, thus performing sterilization activity.

According to example embodiments, a sterilizing catalyst includes a metal lattice including a metal oxide, and an oxygen vacancy-inducing metal that is integrated or encompassed within the metal lattice. The metal oxide is an oxide of a divalent or multivalent metal. The oxygen vacancy-inducing metal has an oxidation number lower than that of the divalent or multivalent metal.

The diameter of the oxygen vacancy-inducing metal may be smaller than the diameter of the divalent or multivalent metal in the metal oxide.

The divalent or multivalent metal is selected from Group 4, Group 5, Group 6, Group 13, Group 14, and Group 1 elements, excluding boron, carbon, and nitrogen.

The metal oxide may include TiO₂, SiO₂, CeₓZr₁₋ₓO₂ (0≦x<1), SiO₂—Al₂O₃, SiO₂—ZrO₂, Al₂O₃—ZrO₂, CeO—ZrO₂ or a combination thereof.

The oxygen vacancy-inducing metal may include silver (Ag), copper (Cu), zinc (Zn), cobalt (Co), nickel (Ni), manganese (Mn) or a combination thereof.

A lattice frame of the metal lattice including the metal oxide may be identical to a lattice frame where the oxygen vacancy-inducing metal is not integrated or encompassed within the metal lattice.

The sterilizing catalyst may produce a reactive oxygen species under temperature of about 4° C. to about 30° C. and in a dark condition.

The oxygen vacancy-inducing metal may consist of about 0.1 to 20 wt % of the entire sterilizing catalyst.

In the sterilizing catalyst, the oxygen vacancy-inducing metal may not be ionized in an aqueous solution.

The sterilizing catalyst may exclude (i.e., not include) an additional metal selected from platinum (Pt), palladium (Pd), ruthenium (Ru), rhodium (Rh), gold (Au) and a combination thereof.

The sterilizing catalyst may be used for sterilization under temperature of about 4° C. to about 30° C. and in a dark condition.

According to other example embodiments, a sterilizing device is provided that has a coating layer including the above-described sterilizing catalyst.

According to still other example embodiments, a sterilizing system is provided that includes the above-described sterilizing catalyst, and a reactive oxygen species formed from the sterilizing catalyst.

The divalent or multivalent metal may have a variable oxidation state, whereby the reactive oxygen species is formed from an oxygen vacancy induced by a change in the oxidation state of the divalent or multivalent metal due to the introduction of the oxygen vacancy-inducing metal in the sterilizing catalyst.

Reactive oxygen species may be produced (or exist) under temperature of about 4° C. to about 30° C. and in a dark condition.

### BRIEF DESCRIPTION OF THE DRAWINGS

FIG. 1 is a graph showing XRD analysis results of catalyst samples obtained in Example 1, Example 2, and Comparative Example 1.

FIG. 2 is a graph showing remaining Ag amounts of catalyst samples prepared in Example 1, Example 2 and Comparative Example 2 with time, measured after adding the catalyst samples to a microorganism culture.

FIG. 3 is a graph showing electron spin resonance (ESR) measurement results of the catalyst samples prepared in Comparative Example 1, Example 1 and Example 2.

FIG. 4 is a magnified graph of the ESR measurement graph of Example 1 of FIG. 3.

FIG. 5 is a graph showing microorganism concentrations of the catalyst samples of Comparative Example 1, Comparative Example 2, Example 1 and Example 2, measured after conducting sterilization tests using each of the catalyst samples.

FIG. 6 is a graph showing the effect of dissolved oxygen on sterilization performance of the catalyst samples of Example 1 and Example 2, measured after conducting sterilization tests using each of the catalyst samples.

FIG. 7 is an illustration of a coating ball including the metal oxide sterilized catalyst according to example embodiments;

FIGS. 8 and 9 are illustrations of a filter used in a sterilizing method according to example embodiments.

FIG. 10 illustrates a sterilizing device including the sterilizing catalyst according to example embodiments.

### DETAILED DESCRIPTION

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

Example embodiments relate to a metal oxide sterilizing catalyst, a sterilizing device and a sterilizing system using the same.

First, a sterilizing catalyst according to example embodiments is explained.

The sterilizing catalyst according to example embodiments includes a metal lattice including a metal oxide, and an oxygen vacancy-inducing metal that is substituted for a portion of (or integrated in) the metal lattice or is inserted in (or encompassed within) a space between the lattice.

The metal oxide is an oxide of a divalent or multivalent metal. The oxidation number of the oxygen vacancy-inducing metal is lower than the oxidation number of the divalent or multivalent metal in the metal oxide.

The frame of the metal lattice may be maintained by substitution and/or insertion of the oxygen vacancy-inducing metal without deformation. Specifically, the sterilizing catalyst may have a lattice frame identical to the lattice frame of a metal oxide in which the oxygen vacancy-inducing metal is not substituted or inserted.

To maintain the lattice frame, after substitution or insertion of the oxygen vacancy-inducing metal in the metal oxide, an oxygen vacancy-inducing metal having a diameter smaller than that of the metal in the metal oxide may be selected.

Because the metal oxide is an oxide of a divalent or multivalent metal and the oxidation number of the oxygen vacancy-inducing metal is lower than the oxidation number of the metal of the metal oxide, substitution or insertion of the oxygen vacancy-inducing metal in the lattice frame of the metal oxide may induce an oxygen vacancy.

Specific examples of the metal oxide may include an oxide of a metal selected from Group 4, Group 5, Group 6, Group 13, Group 14 and Group 15 elements, except boron, carbon, and nitrogen.

The induced oxygen vacancy may cause adsorption of water, oxygen, etc. due to its electron-attracting property, and the adsorbed water or oxygen may be oxidized to a reactive oxygen species (e.g., a superoxide anion radical (O₂⁻), a hydroxide radical (OH), hydrogen peroxide H₂O₂, etc.). The produced reactive oxygen species may oxidize microorganisms to perform sterilization. Alternatively, the oxygen vacancy of the metal oxide may directly take up electrons from microorganisms thus performing sterilization by oxidation.

As explained, because sterilization is performed by a reactive oxygen species rather than by an oxygen vacancy-inducing metal or other reactive metal(s) released from the sterilizing catalyst, sterilization performance of the sterilizing catalyst may be stably maintained for a longer period of time, and a semi-permanent antibacterial life-span may be realized.

Thus, the oxygen vacancy-inducing metal may not be substantially released from the sterilizing catalyst during sterilization (i.e., the oxygen vacancy-inducing metal may be retained).

In addition, the oxygen vacancy-inducing metal may not be ionized and released in an aqueous solution, and is firmly maintained integrated or interstitially in the lattice of the metal oxide.

Because the sterilizing catalyst according to example embodiments may perform sterilization using a reactive oxygen species generated from an oxygen vacancy that is induced by an oxygen vacancy-inducing metal substituted or inserted in the lattice of the metal oxide, it may not be required to further include an active metal (e.g., platinum (Pt), palladium (Pd), ruthenium (Ru), rhodium (Rh), gold (Au) or a similar metal) in the metal oxide, but is not limited thereto. Thus, the sterilizing catalyst may, or may not, include the active metal.

Because specific conditions including additional energy supply (e.g., high temperature or light) may not be required to generate reactive oxygen species from the induced oxygen vacancy, sterilization may be performed under (or in) a dark condition, or at low temperature to room temperature. Specifically, because the generation of reactive oxygen species is not related to additional energy supply (e.g., temperature condition), the reactive oxygen species may exhibit an excellent sterilizing effect at any temperature, and similarly, the reactive oxygen species may be generated even under (or in) a substantially dark condition wherein solar light is not provided to exhibit an excellent sterilizing effect. As explained, because an excellent sterilizing effect may be obtained at low temperature to room temperature as well as at a high temperature, the reactive oxygen species may be produced for example at a temperature of about 4° C. to about 30° C. and under dark conditions.

Specific examples of the metal oxide may include TiO₂, SiO₂, CeₓZr₁₋ₓO₂ (0≦x<1), SiO₂—Al₂O₃, SiO₂—ZrO₂, Al₂O₃—ZrO₂, CeO—ZrO₂ and a combination thereof.

Specific examples of the oxygen vacancy-inducing metal may include Ag, Cu, Zn, Co, Mn and a combination thereof.

According to example embodiments, the sterilizing catalyst may include the oxygen vacancy-inducing metal in a content of about 0.1 to 20 wt % of the entire sterilizing catalyst. If the oxygen vacancy inducing metal is included within the above range, the structure of the metal oxide may be firmly maintained and the oxygen vacancy degree may be increased.

The sterilizing catalyst may be applied for a product or system requiring antibacterial, sterilizing performance.

According to yet other example embodiments, a sterilizing device is provided that has a coating layer including the above-described sterilizing catalyst.

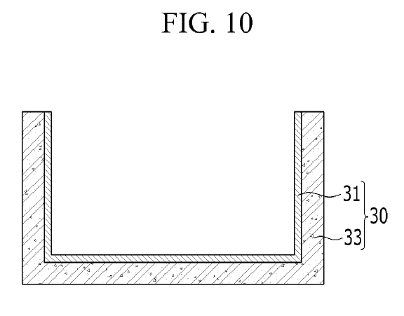

Specific examples of the sterilizing device may include systems requiring sterilized water (e.g., water purifiers, water reservoirs, humidifiers, etc.), and systems requiring sterilization of air (e.g., air purifiers, various household items requiring a sterilizing function, etc.). As an example, FIG. 10 illustrates a water reservoir 30 as one example of the sterilizing device according to example embodiments. The water reservoir 30 may include a coating layer 31 and a container 33. The coating layer 31 may include the sterilizing catalyst according to example embodiments.

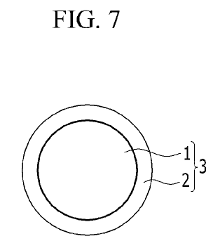

The coating layer may be prepared by a known coating layer manufacturing method without specific limitation, and for example, it may be manufactured by preparing an aqueous solution composition including the sterilizing catalyst, coating the aqueous solution composition on a subject, and drying. For example, as illustrated in FIG. 7, a coating ball 3 may be formed by coating the coating layer 2 on an alumina ball, and prepared in the form of a ceramic ball 1.

According to still other example embodiments, a sterilizing system is provided that includes the above-described sterilizing catalyst and a reactive oxygen species induced from the sterilizing catalyst. Specifically, the sterilizing catalyst making up the sterilizing system includes an oxygen vacancy-inducing metal that is substituted for (or integrated in) a metal lattice of a metal oxide, or inserted in (or encompassed within) a space between lattice. The metal oxide is an oxide of a divalent or multivalent metal, and the oxidation number of the oxygen vacancy-inducing metal is lower than the oxidation number of the metal of the metal oxide.

The reactive oxygen species may be produced by an oxygen vacancy that is caused by a change in the oxidation state of a metal making up a lattice of the sterilizing catalyst due to introduction of an oxygen vacancy-inducing metal having a smaller oxidation number than a metal oxide in the sterilizing catalyst.

As explained above, generation of the reactive oxygen species may not require additional energy supply, so sterilization may be performed at low temperature to room temperature, or under dark conditions.

Specifically, because generation of the reactive oxygen species is not related to additional energy supply (e.g., a temperature condition), the sterilizing catalyst may generate a reactive oxygen species at any temperature that exhibits an excellent sterilizing effect, and similarly, it may generate a reactive oxygen species even under a dark condition that exhibits an excellent sterilizing effect. As explained, because an excellent sterilizing effect may be obtained at a low temperature to room temperature as well as at a high temperature, the reactive oxygen species may be produced for example at temperature of about 4° C. to about 30° C. and under dark condition.

Hereinafter, a method of manufacturing a sterilizing catalyst is explained in detail.

The sterilizing catalyst may be prepared by various methods (e.g., evaporation-induced self-assembly, co-precipitation, etc.).

According to the evaporation-induced self assembly, a metal oxide precursor and an oxygen vacancy inducing metal precursor are added to a solvent to prepare a mixed solution, the mixed solution is then dried and aged, and the resultant product is baked to form an oxide catalyst with a porous structure.

As the solvent mixed with the precursors, an alcohol-type solvent (e.g., methanol, ethanol, etc.) may be used, and an acid (e.g., a hydrochloric acid, a nitric acid, an acetic acid, etc.) may be mixed therewith. The content of the solvent may not be specifically limited, but it may be included in the content of about 0.1 to about 40 parts by weight based on 100 parts by weight of the oxide precursor.

The metal oxide precursor and the oxygen vacancy-inducing metal precursor are mixed with the solvent to form a mixed solution, and a structure-forming agent may be further added thereto. The structure-forming agent may provide a backbone of the metal oxide, and, for example, a neutral surfactant may be used. Specific examples of the neutral surfactant may include a polyethylene oxide/polypropylene oxide/polyethylene oxide (PEO/PPO/PEO) triblock copolymer of the product name Pluronic F108, F127, etc.

As the oxygen vacancy-inducing metal precursor used in the manufacturing process, a compound (e.g., an alkoxide, a halide, a nitrate, a chlorate, a sulfate, or an acetate) which includes a metal selected from Ag, Cu, Zn, Co, and Mn may be used.

As the metal oxide precursor used in the manufacturing process, a compound (e.g., an alkoxide, a halide, a nitrate, a chlorate, a sulfate, or an acetate) which includes at least one metal selected from Group 4, Group 5, Group 6, Group 13, Group 14 and Group 15 elements (except boron, carbon, and nitrogen) may be used. For example, a compound (e.g., an alkoxide, a halide, a nitrate, a chlorate, a sulfate, or an acetate) which includes an element selected from Si, Al, Ti, Zr, and Ce may be used, but is not limited thereto.

In the manufacturing process, if one type of the metal oxide precursor is used, a single metal oxide may be formed. If two or more types of the metal oxide precursors are used, a composite metal oxide may be formed. A support for the single metal oxide may include TiO₂ or SiO₂, and a support for the composite metal oxide may include CeₓZr₁₋ₓO₂ (0≦x≦1), SiO₂—Al₂O₃, SiO₂—ZrO₂, Al₂O₃—ZrO₂, and CeO—ZrO₂ and a combination thereof.

The mixed solution including a solvent, a catalyst metal precursor, and a metal oxide precursor, and if necessary, an acid or a structure-directing agent may be agitated at room temperature (about 24° C.) for about 0.1 to about 10 hours to homogenize each component.

The obtained mixed solution may be allowed to stand at room temperature (about 24° C.) and atmospheric pressure (about 1 atm) for about 1 to about 100 hours to remove a volatile solvent component in the mixed solution. The standing time may not be specifically limited as long as it may remove the volatile solvent component.

The product obtained after removing the solvent component, if necessary, may be subjected to an aging process. The aging process increases the bonding degree between atoms forming the structure, and it may be conducted at an elevated temperature of about 30 to about 100° C. for about 6 to about 48 hours.

Next, the product passing the aging process may be subjected to a baking process whereby each precursor may be transformed to an oxide. The baking process may be conducted in the atmosphere, in the temperature range of from about 300° C. to about 1000° C., specifically from about 350° C. to about 600° C., for about 0.1 to about 30 hours, specifically for about 1 to about 10 hours.

Each precursor may be transformed to a metal oxide by the baking process, during which the metal oxide forms a mesopore structure, and the oxygen vacancy inducing metal becomes substituted and/or inserted in the backbone of the metal oxide.

According to co-precipitation, which is another method for manufacturing the sterilizing catalyst, a basic aqueous solution is added to a water dispersion including the precursors to form a precipitate in the form of a hydroxide, and then the precipitate is filtered and washed and the resultant product is baked to prepare a sterilizing catalyst. The type of precursor and baking conditions are identical to the evaporation-induced self assembly.

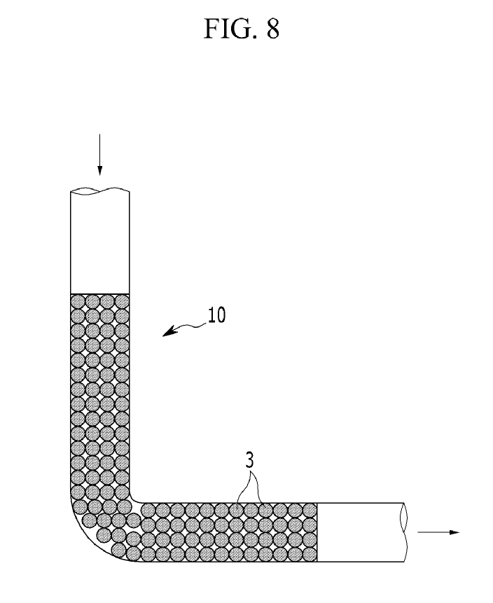

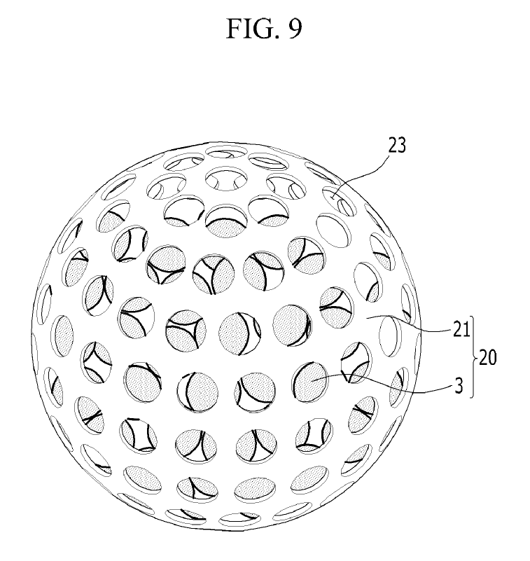

FIGS. 8 and 9 are illustrations of a filter used in the above-described sterilizing method according to example embodiments. In FIG. 8, a filter 10 is filled with the coating ball 3. Water may be purified in the filter 10 in the direction of arrows. It is noted that the shape of the filter 10 is not limited to the shape depicted in FIG. 8, but rather is provided for illustration purposes. In FIG. 9, a filter 20 may be in the shape of a relatively large hollow ball 21 including the coating balls 3. The hollow ball 21 may have a plurality of holes 23 on its surface. The plurality of holes may prevent or reduce the movement of the coating balls 3 therethrough, because the diameter of the plurality of holes 23 is smaller than the diameter of the coating ball 3.

Among the manufacturing processes, the evaporation-induced self assembly is favorable for obtaining a uniform catalyst having a pore size of narrow distribution, and the co-precipitation is favorable for obtaining a catalyst having various pore sizes.

As explained, because manufacturing of the sterilizing catalyst may be conducted simply by baking the precursors, it may be prepared with a low cost, thus enabling manufacture of a high efficiency and low cost composite catalyst.

Hereinafter, the example embodiments are illustrated in more detail with reference to the following examples. However, the following are exemplary embodiments and are not limiting.

### EXAMPLES

### Example 1

### Preparation of Ce_{0.85}Ag_{0.005}Zr_{0.1}O_{1.925}

An oxygen vacancy inducing metal (Ag) is substituted (or integrated) in a metal oxide lattice to synthesize a Ce_{0.85}Ag_{0.05}Zr_{0.1}O_{1.925} sterilizing catalyst as follows.

ethanol: 30 ml

hydrochloric acid: 1.97 ml

Pluronic: 4.6 g

(PEO/PPO/Peo Triblock Copolymer)

acetic acid: 2.4 g

Ce(NO₃)₃: 9.23 g

AgNO₃: 0.21 g

Zr(OC₄H₉)₄: 1.2 g

The above components are introduced into a beaker and agitated at room temperature for 5 hours. Subsequently, the mixture is dried at room temperature for 2 days and aged at 338 K for 12 hours. The resultant product is baked at 673 K for 5 hours to prepare a Ce_{0.85}Ag_{0.05}Zr_{0.1}O_{1.95} sterilizing catalyst. The content of the metal precursor used is such that the mole ratio of CeNO₃₃:AgNO₃:Zr (OC₄H₉)₄ is about 0.85:0.05:0.1, thus stoichiometrically substituting Ag in the oxide backbone.

### Example 2

### Preparation of Ag_{0.05}Ce_{0.9}Zr_{0.1}O₂

An antibacterial metal is substituted and inserted (i.e., integrated and encompassed) in a metal oxide lattice to synthesize a Ag_{0.05}_{_{—}}Ce_{0.9}Zr_{0.1}O₂ sterilizing catalyst as follows.

ethanol: 30 ml

hydrochloric acid: 1.97 ml

Pluronic F127: 4.6 g

acetic acid: 2.4 g

Ce(NO₃)₃: 9.77 g

AgNO₃: 0.21 g

Zr(OBu)₄: 1.2 g

The above components are introduced into a beaker and agitated at room temperature for 5 hours. Subsequently, the mixture is dried at room temperature for 2 days and aged at 338 K for 12 hours. The resultant product is baked at 673 K for 5 hours to prepare a Ag_{0.05}_{_{—}}Ce_{0.9}Zr_{0.1}O₂ sterilizing catalyst.

The content of the metal precursor used is such that the mole ratio of CeNO₃₃:AgNO₃:Zr (OC₄H₉)₄ is about 0.9:0.05:0.1, thus inserting excessive Ag in the space between metal oxide lattices. Because the prepared sterilizing catalyst includes substituted and inserted Ag ions, it is indicated as Ag_{0.05}_{_{—}}Ce_{0.9}Zr_{0.1}O₂ so as to distinguish it from the sterilizing catalyst of Example 1 including only substituted Ag.

### Comparative Example 1

### Preparation of Ce_{0.9}Zr_{0.1}O₂

ethanol: 30 ml

hydrochloric acid: 1.97 ml (or nitric acid having the same mole ratio)

Pluronic F127: 4.6 g

acetic acid: 2.4 g

Ce(NO₃)₃: 9.77 g (metal precursor mole ratio: 0.9)

Zr(OBu)₄: 1.2 g (metal precursor mole ratio: 0.1)

The above components are introduced into a beaker, and agitated at room temperature for 5 hours. Subsequently, the mixture is dried at room temperature for 2 days and aged at 338 K for 12 hours. The resultant product is baked at 673 K for 5 hours to prepare a Ce_{0.9}Zr_{0.1}O₂ metal oxide catalyst.

### Comparative Example 2

### Preparation of Ag-Zeolite

Na—Y zeolite (Tosoh Corporation) 2 g

0.1M AgNO₃ 50 ml

2 g of a Na—Y zeolite is baked for 4 hours while maintaining the temperature at 400° C. Then, the baked Na—Y zeolite is introduced into 50 ml of an AgNO₃ solution of a 0.1M concentration, and agitated for 5 hours while maintaining the temperature at 60° C. to conduct ion exchange. The ion-exchanged Ag—Y zeolite is filtered and washed with deionized water. The washed Ag—Y zeolite is dried for 16 hours while maintaining the temperature at 110° C. The dried Ag—Y zeolite is introduced into a heating furnace and baked for 4 hours while maintaining the temperature at 400° C.

### Experimental Example 1

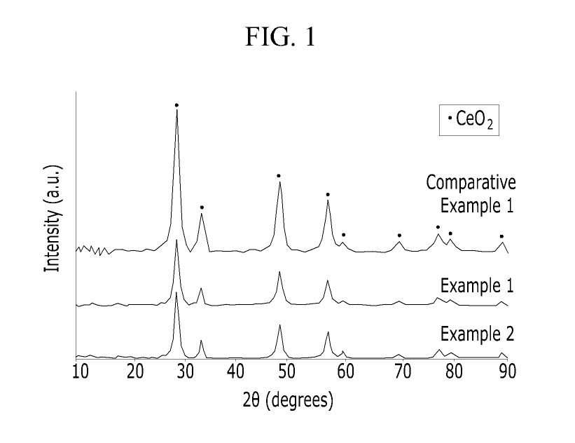

FIG. 1 shows XRD analysis results of the catalyst samples obtained in Example 1, Example 2 and Comparative Example 1. From FIG. 1, it is observed that all the sterilizing catalysts of Example 1, Example 2, and Comparative Example 1 show the same peaks as a CeO₂ lattice without peaks of other atoms. Thus, it can be seen that an antibacterial metal element (Ag) is stably substituted or inserted in the CeO₂ lattice in the sterilizing catalysts of Example 1 and Example 2.

### Experimental Example 2

### Silver Ion Release

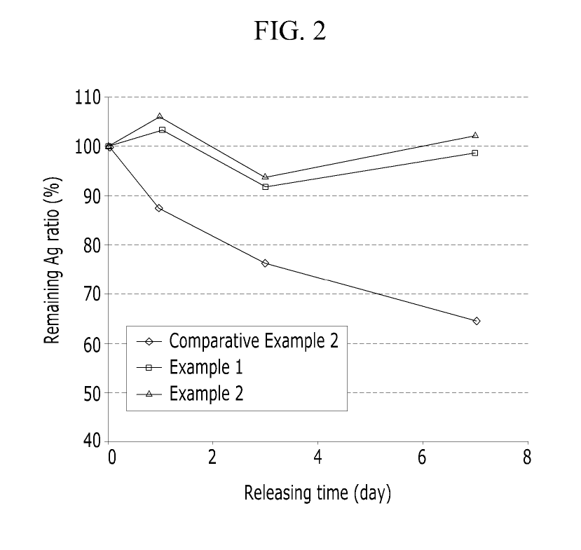

To determine whether or not silver ions are released when the sterilizing catalysts prepared in Example 1, Example 2 and Comparative Example 2 are exposed to an aqueous solution, a release test is performed. 20 ml of an LB (Luria Bertani) solution (microorganism culture) of a 0.25 wt % concentration is introduced into a 50 mL Falcon tube, and then, 100 mg of each of the sterilizing catalysts of Example 1, Example 2 and Comparative Example 2 are introduced therein and disposed in a shaking incubator. The elution test is conducted at 25° C., 150 rpm for 1 week, and the sample is taken out respectively at 1, 3, and 7 days. The sample is centrifuged at 7000 rpm for 10 minutes and then vacuum-dried at 90° C. The Ag content change of each sample before and after the release test is observed by ICP-AES (inductively coupled plasma-atomic emission spectrometer) analysis, and the results are shown in FIG. 2.

As a result of release test, it is observed that the Ag content remarkably decreases with time lapse in the sterilizing catalyst of Comparative Example 2 (about 65% of initial value after 7 days), while a significant change is not observed in the sterilizing catalysts of Example 1 and Example 2. Therefore, it is confirmed that Ag⁺ is not substantially released in the sterilizing catalysts of Example 1 and Example 2.

### Experimental Example 2-1

### Silver Ion Release

20 ml of an LB (Luria Bertani) solution (microorganism culture) of a 0.25 wt % concentration is introduced into a 50 mL Falcon tube, and then each catalyst sample of Example 1 and Example 2 is introduced therein in the concentrations as described in the following Table 1 and disposed in a shaking incubator. The mixture is agitated at 25° C., 150 rpm for 24 hours, and silver ion concentration of the microorganism culture to which the sample is added is measured and described in the following Table 1. Silver ions are analyzed by anodic stripping voltammetry, wherein a silver ion concentration of 0 ppb means less than 10 ppb because the detection limit is 10 ppb.

TABLE 1

| | CONCENTRATION OF | |
|---|---|---|
| | SAMPLE INTRODUCED | |
| | IN THE CULTURE (PPB) | [AG+] (PPB) |
| EXAMPLE 1 | 100,000 | 0 |
| | 10,000 | 0 |
| | 5000 | 0 |
| EXAMPLE 2 | 100,000 | 0 |
| | 10,000 | 0 |
| | 5000 | 0 |

From the results of Table 1, it is confirmed that the release amounts of silver ions are insignificant in the sterilizing catalysts of Example 1 and Example 2.

### Experimental Example 3

### Reactive Oxygen Species

For the catalyst samples prepared in Comparative Example 1, Example 1 and Example 2, radicals are detected by electron spin resonance (ESR, JES-TE200, JEOL, Japan) analysis to confirm generation of reactive oxygen species.

As a spin-trapping agent, DMPO (5,5-dimethyl-1-pyrroline N-oxide, sigma) is used, and ESR analysis conditions are as follows: temperature of 25° C., frequency of 9.4 GHz, scan range of 100 G, field set of 3410 G (341 mT), time constant of 0.3 s, scan time of 4 min, modulation amplitude of 4, modulation frequency of 100 kHz, and microwave power of 1 mW. A test solution is prepared by introducing 10 mg of the sterilizing catalyst and 25 ul of a DMPO solution (final concentration 0.5 mM) into 500 ul of distilled water, and the solution is introduced into an ESR tube and analyzed.

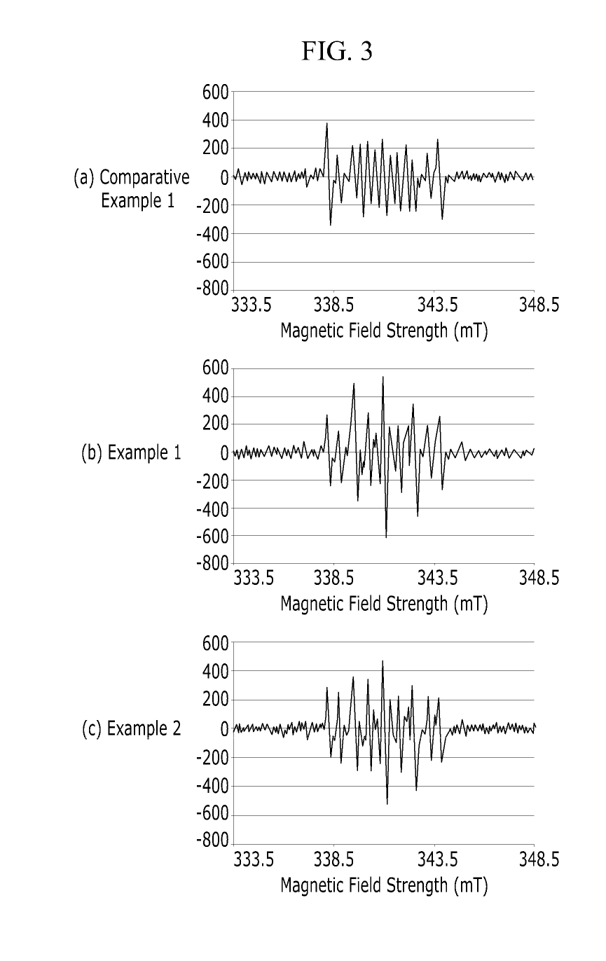

The ESR measurement results are described in FIG. 3. It is shown that radicals are not substantially detected in Comparative Example 1 of FIG. 3(a), and radicals are detected in Example 1 of FIG. 3(b) and Example 2 of FIG. 3(c). From these results, it can be seen that reactive oxygen species are not produced in Comparative Example 1, while reactive oxygen species are produced in Example 1 and Example 2.

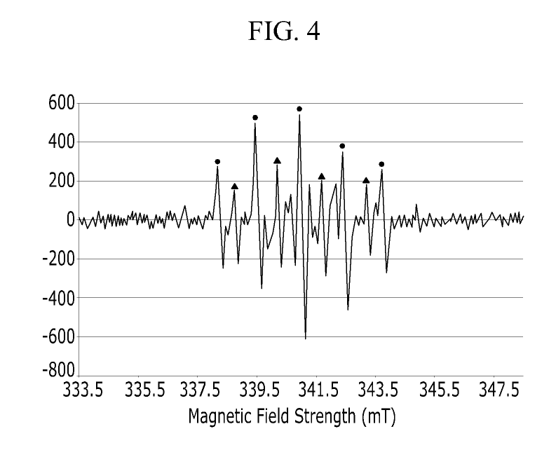

FIG. 4 is a magnification of the graph of Example 1 of FIG. 3(b), wherein the ratio of areas of 4 peaks indicated as triangles is 1:2:2:1, and the peak interval is regular at 15 G (1.5 mT), thus the peaks are analyzed as typical peaks of hydroxide radicals. Therefore, it can be seen that multiple reactive oxygen species including hydroxide radicals are generated.

### Experimental Example 4

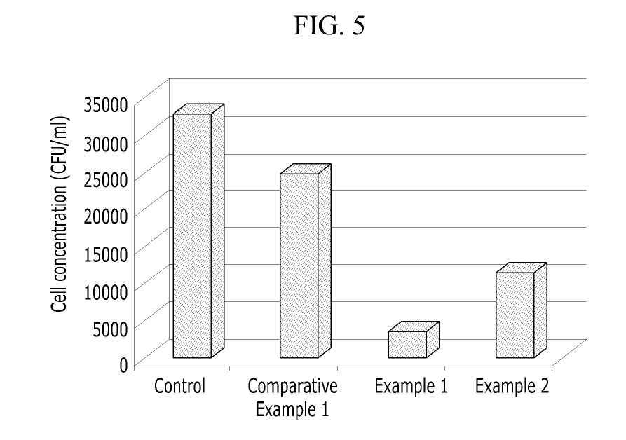

For a control of E. coli having an initial concentration of 32,000 CFU/ml and the sterilizing catalysts of Comparative Example 1, Example 1, and Example 2, sterilizing tests are conducted at 25° C. with a catalyst concentration of 1 mg/20 ml, and the results are shown in FIG. 5.

It is observed that microorganisms are grown to increase the concentration in the control where no sterilizing catalyst is introduced, while Comparative Example 1 exhibits weak sterilizing performance (about a 20% decrease in microorganism concentration). On the contrary, it is confirmed that about 90% and about 70% of the microorganisms are respectively sterilized in Example 1 and Example 2, indicating that sterilizing performance is improved.

### Experimental Example 5

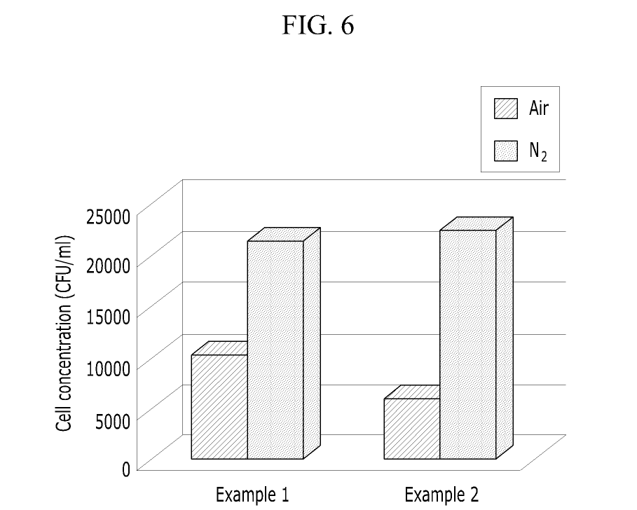

For E. coli of an initial concentration of 32,000 CFU/ml and the sterilizing catalysts of Example 1 and Example 2, sterilizing tests are conducted at 25° C. with the catalyst concentration of 1 mg/20 ml, respectively, under an air condition where air is added by agitation and under a N₂ condition wherein dissolved oxygen is decreased by bubbling. The results are shown in FIG. 6.

From FIG. 6, it is observed that microorganism sterilizing performance is significantly different under an N₂ condition compared to an air condition. Therefore, it can be seen that reactive oxygen species are very important in the sterilizing mechanism of the sterilizing catalysts of Example 1 and Example 2.

### Experimental Example 6

To confirm the sterilizing effect according to silver ion concentration, test solutions are prepared with a AgNO₃ reagent so as to have silver ion concentrations described in the left column of the following Table 2. 20 ml of an LB solution (microorganism culture medium) of a 0.25 wt % concentration is introduced into a 50 mL Falcon tube, and then the AgNO₃ reagent is added with each silver ion concentration of Table 2, and sterilizing is conducted at 25° C. An initial concentration of E. coli is 10,000 CFU/ml. Further, each E. coli concentration is measured and described in the following Table 2.

TABLE 2

| [Ag+] (ppb) | E. coli (CFU/mL) |
|---|---|
| 0 | 310,000,000 |
| 1 | 370,000,000 |
| 5 | 54,500,000 |
| 10 | 14,500 |
| 15 | 140 |
| 20 | 20 |

From the results of Table 2, it can be seen that at least about 15 ppb or more of silver ion release concentration is required for use as a sterilizing catalyst. Comparing these results with the sterilizing effects of Example 1 and Example 2 as shown in Experimental Example 2, Experimental Example 4, and Experimental Example 5, it can be seen that the sterilizing effects of Example 1 and Example 2 are not derived from the silver ion release concentration because Example 1 and Example 2 exhibit sterilizing effects in spite of silver ion release concentrations of less than 10 ppb. Specifically, the sterilizing effects of Example 1 and Example 2 are derived from reactive oxygen species, and thus excellent sterilizing effects are obtained in spite of a low silver ion elution concentration.

While this disclosure has been described in connection with what is presently considered to be practical example embodiments, it is to be understood that the invention is not limited to the disclosed example embodiments, but, on the contrary, is intended to cover various modifications and equivalent arrangements included within the spirit and scope of the appended claims.

What is claimed is:

1. A sterilizing catalyst, comprising:
a metal lattice including a metal oxide, wherein the metal oxide is an oxide of a divalent or multivalent metal; and
an oxygen vacancy-inducing metal that is integrated or encompassed within the metal lattice,
wherein the oxygen vacancy-inducing metal has an oxidation number lower than that of the divalent or multivalent metal.

2. The sterilizing catalyst of claim 1, wherein the oxygen vacancy-inducing metal has a diameter smaller than that of the divalent or multivalent metal.

3. The sterilizing catalyst of claim 1, wherein the divalent or multivalent metal is selected from the group consisting of Group 4, Group 5, Group 6, Group 13, Group 14 and Group 15 elements, excluding boron, carbon, and nitrogen.

4. The sterilizing catalyst of claim 1, wherein the metal oxide is selected from TiO₂, SiO₂, CeₓZr₁₋ₓO₂ (0≦x<1), SiO₂—Al₂O₃, SiO₂—ZrO₂, Al₂O₃—ZrO₂, CeO—ZrO₂ and a combination thereof.

5. The sterilizing catalyst of claim 1, wherein the oxygen vacancy-inducing metal is selected from silver (Ag), copper (Cu), zinc (Zn), cobalt (Co), nickel (Ni), manganese (Mn) and a combination thereof.

6. The sterilizing catalyst of claim 1, wherein a lattice frame of the metal lattice including the metal oxide is identical to a lattice frame where the oxygen vacancy-inducing metal is not integrated or encompassed within the metal lattice.

7. The sterilizing catalyst of claim 1, wherein the sterilizing catalyst produces a reactive oxygen species under a temperature of about 4° C. to about 30° C. and in a dark condition.

8. The sterilizing catalyst of claim 1, wherein the oxygen vacancy-inducing metal consists of about 0.1 to 20 wt % of the entire sterilizing catalyst.

9. The sterilizing catalyst of claim 1, wherein the oxygen vacancy-inducing metal is not ionized in an aqueous solution.

10. The sterilizing catalyst of claim 1, wherein an additional metal selected from platinum (Pt), palladium (Pd), ruthenium (Ru), rhodium (Rh), gold (Au) and a combination thereof is excluded.

11. The sterilizing catalyst of claim 1, wherein the sterilizing catalyst sterilizes under a temperature of about 4 to about 30° C. and in dark condition.

12. A sterilizing device, comprising:
a coating layer including the sterilizing catalyst according to claim 1.

13. A sterilizing system, comprising:
the sterilizing catalyst according to claim 1; and
a reactive oxygen species formed from the sterilizing catalyst.

14. The sterilizing system of claim 13, wherein the divalent or multivalent metal has a variable oxidation state, whereby the reactive oxygen species is formed from an oxygen vacancy induced by a change in the oxidation state of the divalent or multivalent metal due to the introduction of the oxygen vacancy-inducing metal in the sterilizing catalyst.

15. The sterilizing system of claim 13, wherein the reactive oxygen species exists in a temperature of about 4° C. to about 30° C. and in a dark condition.
